(19) United States
(12) Patent Application Publication
(10) Pub. No.: US 2025/0126387 A1
(43) Pub. Date: Apr. 17, 2025

(54) MICROPHONE MODULE AND DEFROSTING METHOD

(71) Applicant: AAC ACOUSTIC TECHNOLOGIES (SHENZHEN) CO., LTD., Shenzhen (CN)

(72) Inventor: Jinyu Zhang, Shenzhen (CN)

(21) Appl. No.: 18/398,087

(22) Filed: Dec. 27, 2023

Related U.S. Application Data
(63) Continuation of application No. PCT/CN2023/124123, filed on Oct. 12, 2023.

(51) Int. Cl. H04R 1/08; H05B 1/02

(52) U.S. Cl. CPC H04R 1/083; H05B 1/0227; H05B 2214/02

(57) ABSTRACT

A microphone module includes a housing with a receiving space and a microphone mounted in the receiving space. The microphone module further includes a heat-conducting ring embedded in the housing and a heating unit connected to the heat-conducting ring. A sound hole corresponding to a position of the microphone is formed inside the heat-conducting ring. The heating unit is configured to provide heat for the heat-conducting ring. The defrosting method includes the following steps: enabling a heating action of the heating unit in response to a heating instruction; and detecting current performance of the microphone, and disabling the heating action of the heating unit if the current performance of the microphone is normal. According to the solution, water, frost or ice can be removed from the sound hole to prevent clogging of the sound hole, thereby ensuring normal performance of the microphone.

### CROSS-REFERENCE TO RELATED APPLICATIONS

This application is a continuation of International Application No. PCT/CN2023/124123, filed on Oct. 12, 2023, which is hereby incorporated by reference in its entirety.

### TECHNICAL FIELD

The present disclosure relates to the field of acoustoelectric conversion technologies, and in particular, to a microphone module and a defrosting method.

### BACKGROUND

A microphone is a device that converts sound signals into electrical signals, which is commonly used in an electronic terminal such as a mobile phone, a tablet computer, or a voice recorder.

In the related art, a sound hole of the microphone in the electronic terminal is generally a blind hole with a closed outer end, and the outer end of the sound hole is generally provided with a decorative grille.

Under outdoor conditions, rainwater easily enters the sound hole. When a temperature is below a dew point, dew or frost may be formed, and internal moisture is difficult to evaporate. When the temperature is below a freezing point, the internal moisture may also freeze. Both water and ice can lead to clogging of the sound hole, affecting a normal function of the microphone.

### SUMMARY

The present disclosure is intended to provide a microphone module and a defrosting method, which can remove water and/or ice in the sound hole of the microphone and ensure normal performance of the microphone.

The technical solutions of the present disclosure are as follows.

A first aspect of the present disclosure provides a microphone module. The microphone module includes a housing with a receiving space and a microphone mounted in the receiving space. The microphone module further includes a heat-conducting ring embedded in the housing and a heating unit connected to the heat-conducting ring. A sound hole corresponding to a position of the microphone is formed inside the heat-conducting ring. The heating unit is configured to provide heat for the heat-conducting ring.

In an embodiment, the heating unit is in a shape of an annular sheet, the heating unit is attached to a side of the heat-conducting ring close to the receiving space, and an inner hole of the heating unit surrounds an outer side of the sound hole.

In an embodiment, the microphone module further includes a printed circuit board assembled in the receiving space and a waterproof film attached to a side of the printed circuit board close to the heating unit, the microphone is assembled on a side of the printed circuit board away from the heating unit, a sound channel is provided on the printed circuit board corresponding to the position of the microphone, and the waterproof film covers one end of the sound channel.

In an embodiment, the microphone module further includes a sealing rubber ring clamped between the heating unit and the waterproof film, and a through hole of the sealing rubber ring surrounds outer sides of the sound hole and the sound channel.

In an embodiment, one side of the housing protrudes to form a connection end, and the printed circuit board includes a connection pin extending from the receiving space into the connection end.

In an embodiment, the microphone module further includes a sound generating unit mounted on the housing and spaced apart from an outer end of the sound hole.

In an embodiment, one side of the housing protrudes to form a mounting platform, and both the sound generating unit and the heat-conducting ring are mounted in the mounting platform.

A second aspect of the present disclosure provides a defrosting method used for the microphone module as described in any one of the above items. The defrosting method includes the following steps:
enabling a heating action of the heating unit in response to a heating instruction; and
detecting current performance of the microphone, and disabling the heating action of the heating unit if the current performance of the microphone is normal.

In an embodiment, prior to the enabling a heating action in response to a heating instruction, the method includes:
controlling the sound generating unit to generate sound, and detecting whether a
signal of the microphone reaches a threshold;
repeating, if the signal of the microphone is greater than or equal to the threshold, the action of controlling the sound generating unit to generate sound, and detecting whether a signal of the microphone reaches a threshold after a first delay duration; and sending the heating instruction to the heating unit if the signal of the microphone is
smaller than the threshold.

In an embodiment, the detecting current performance of the microphone, and disabling the heating action of the heating unit if the current performance of the microphone is normal includes:
controlling the sound generating unit to generate sound, and detecting whether a signal of the microphone reaches a threshold;
disabling, by the heating unit, the heating action if the signal of the microphone is greater than or equal to the threshold; and
repeating, if the signal of the microphone is smaller than the threshold, the action of controlling the sound generating unit to generate sound, and detecting whether a signal of the microphone reaches a threshold after a second delay duration.

The present disclosure has the following beneficial effects.

In the solution, the sound hole is in the heat-conducting ring. Moreover, the heating unit is connected to the heat-conducting ring, and the heating unit may provide heat for the heat-conducting ring. In this way, in a normal state, external sound may be transferred to the microphone through the sound hole of the heat-conducting ring, thereby realizing a normal sound pickup function of the microphone. When there is water, frost or ice in the sound hole, a heating instruction may be sent to the heating unit, and then the heating unit may perform a heating action to heat up the heat-conducting ring. The frost or ice in the sound hole may melt, and the water may evaporate faster as it heats up. At the same time, gas in the clogged sound hole may expand when heated, pushing the water out of the sound hole, thereby removing the water, frost or ice in the sound hole, preventing clogging of the sound hole, and ensuring the normal performance of the microphone. After the water, frost or ice in the sound hole is removed, heating may be stopped, which can effectively save power consumption.

### BRIEF DESCRIPTION OF DRAWINGS

FIG. 1 is a schematic diagram of an overall structure of a microphone module according to the present disclosure;

FIG. 2 is a sectional view of the microphone module along a direction A-A in FIG. 1 according to the present disclosure;

FIG. 3 is a schematic diagram of a three-dimensional exploded structure of the microphone module according to the present disclosure;

FIG. 4 is a schematic flowchart of a defrosting method according to the present disclosure; and

FIG. 5 is a logical block diagram of the defrosting method according to the present disclosure.

### DESCRIPTION OF EMBODIMENTS

The present disclosure is further described below with reference to the accompanying drawings and embodiments.

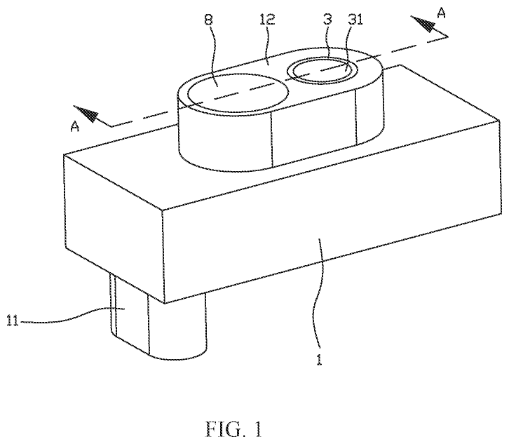

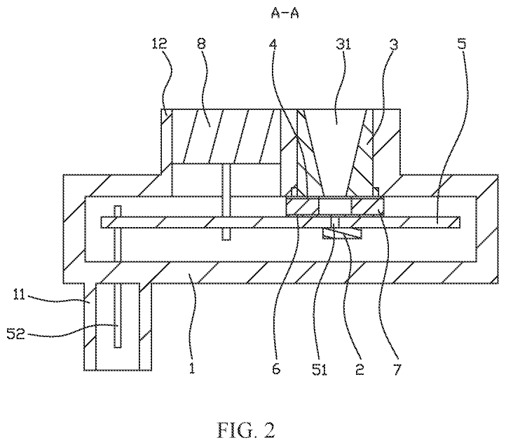

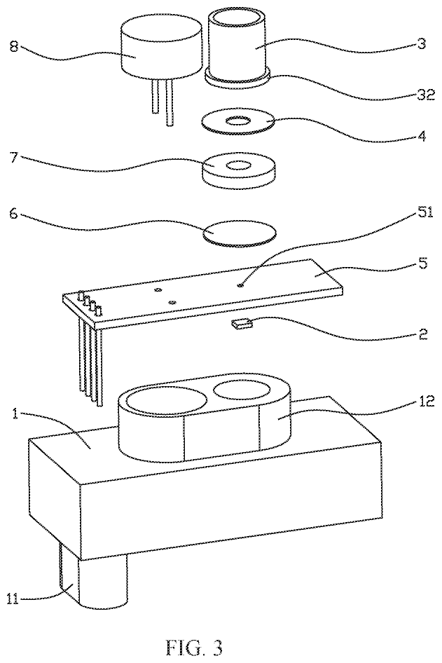

Referring to FIG. 1 to FIG. 3, a microphone module is provided. The microphone module includes a housing 1 with a receiving space and a microphone 2 mounted in the receiving space. The microphone module further includes a heat-conducting ring 3 embedded in the housing 1 and a heating unit 4 connected to the heat-conducting ring 3. A sound hole 31 corresponding to a position of the microphone 2 is formed inside the heat-conducting ring 3. The heating unit 4 is configured to provide heat for the heat-conducting ring 3.

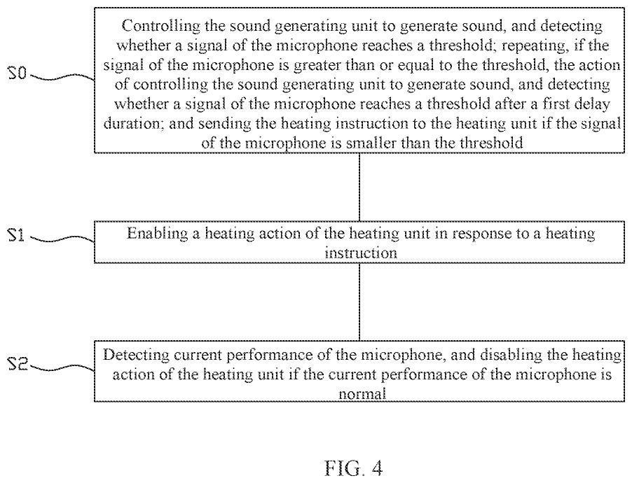

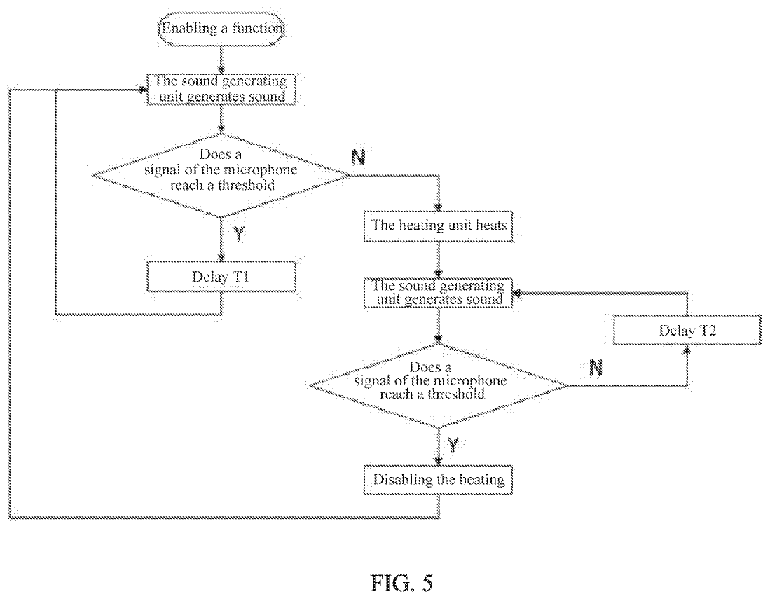

Based on the above microphone module, referring to FIG. 4 and FIG. 5, a defrosting method is provided, including the following steps.

In S10, a heating action of the heating unit 4 is enabled in response to a heating instruction.

In S20, current performance of the microphone 2 is detected, and the heating action of the heating unit 4 is disabled if the current performance of the microphone 2 is normal.

In the solution, the sound hole 31 is in the heat-conducting ring 3. Moreover, the heating unit 4 is connected to the heat-conducting ring 3, and the heating unit 4 may provide heat for the heat-conducting ring 3. In this way, in a normal state, external sound may be transferred to the microphone 2 through the sound hole 31 of the heat-conducting ring 3, thereby realizing a normal sound pickup function. When there is water, frost or ice in the sound hole 31, a heating instruction may be sent to the heating unit 4, and then the heating unit 4 may perform a heating action to heat up the heat-conducting ring 3. The frost or ice in the sound hole 31 may melt, and the water may evaporate faster as it heats up. At the same time, gas in the clogged sound hole 31 may expand when heated, pushing the water out of the sound hole 31, thereby removing the water, frost or ice in the sound hole 31, preventing clogging of the sound hole 31, and ensuring the normal performance of the microphone 2. After the water, frost or ice in the sound hole 31 is removed, heating may be stopped, which can effectively save power consumption.

In an embodiment, the heating unit 4 is in a shape of an annular sheet, the heating unit 4 is attached to a side of the heat-conducting ring 3 close to the receiving space, and an inner hole of the heating unit 4 surrounds an outer side of the sound hole 31. In an embodiment, the heat-conducting ring 3 is made of a thermally conductive material, such as copper, aluminum, or titanium. The sound hole 31 inside the heat-conducting ring 3 is in a shape of a truncated cone. Moreover, a narrow end of the sound hole 31 faces the receiving space of the housing 1, and water or steam is more easily discharged from the sound hole 31 to the outside. A convex ring 32 is formed on an outer side of the heat-conducting ring 3 and close to the receiving space. The convex ring 32 is embedded in the housing 1. The heat-conducting ring 3 may be assembled with the housing 1 by bonding, riveting, or the like, or may be integrally connected to the housing 1 through injection molding. The heating unit 4 and the heat-conducting ring 3 are coaxial. A resistor sheet is used as the heating unit 4. Moreover, an outer diameter of the heating unit 4 is greater than an outer diameter of the heat-conducting ring 3, and an inner diameter of the heating unit 4 is greater than a diameter of the narrow end of the sound hole 31. That is, sound received by the sound hole 31 may not be clogged. Besides, heat emitted by the heating unit 4 may be transferred to a hole wall of the sound hole 31 through the heat-conducting ring 3, so as to be transferred to water, frost or ice to accelerate evaporation or melting.

In some embodiments, the heating unit 4 may include a resistor layer applied to an inner wall of the sound hole 31 of the heat-conducting ring 3, so that the heat generated by the heating unit 4 can be used more efficiently to remove the water, frost or ice.

In an embodiment, the microphone module further includes a printed circuit board 5 assembled in the receiving space and a waterproof film 6 attached to a side of the printed circuit board 5 close to the heating unit 4, the microphone 2 is assembled on a side of the printed circuit board 5 away from the heating unit 4, a sound channel 51 is provided on the printed circuit board 5 corresponding to the position of the microphone 2, and the waterproof film 6 covers one end of the sound channel 51. Through the arrangement of the waterproof film 6, entry of moisture into the microphone 2 can be prevented, and the reliability is higher.

In an embodiment, the microphone module further includes a sealing rubber ring 7 clamped between the heating unit 4 and the waterproof film 6, and a through hole of the sealing rubber ring 7 surrounds outer sides of the sound hole 31 and the sound channel 51. In an embodiment, a silicone ring may be used as the sealing rubber ring 7, the heating unit 4, the sealing rubber ring 7, and the waterproof film have a same outer diameter and are coaxial, and inner diameters of the sealing rubber ring 7 and the heating unit 4 are the same. Through the arrangement of the sealing rubber ring 7, sealing performance between the sound hole 31 and the sound channel 51 can be ensured, which prevents entry of the water into the receiving space of the housing 1 and achieves higher reliability. In addition, the silicone ring has high heat resistance and insulation performance, which, on the one hand, ensures the service life, and on the other hand, can prevent transfer of heat towards the microphone 2, thereby avoiding poor performance of the microphone 2 due to an excessively high temperature.

In an embodiment, the microphone module further includes a sound generating unit 8 mounted on the housing 1 and spaced apart from an outer end of the sound hole 31. In an embodiment, one side of the housing 1 protrudes to form a mounting platform 12, both the sound generating unit 8 and the heat-conducting ring 3 are mounted in the mounting platform 12, and an end face of the microphone 2 and an end face of the heat-conducting ring 3 are both flush with an end face on a side of the mounting platform 12 away from the receiving space. The microphone module, when mounted on an electronic terminal, may be assembled from inside of a shell of the electronic terminal, then the mounting platform 12 is fixed to the shell of the electronic terminal, and an end face of the mounting platform 12 is flush with an outer surface of the shell, which facilitates the mounting and ensures better integrity after the mounting. In this embodiment, an active piezoelectric buzzer is used as the sound generating unit 8, which has characteristics of low power consumption and excellent waterproof performance. It should be understood that, in some embodiments, an electromagnetic buzzer may alternatively be used as the sound generating unit 8.

In an embodiment, one side of the housing 1 protrudes to form a connection end 11, and the printed circuit board 5 includes a connection pin 52 extending from the receiving space into the connection end 11. The connection pin 52 is configured to supply power and transmit signals to the printed circuit board 5, and the printed circuit board 5 in turn supplies power and transmits signals to the sound generating unit 8 and the microphone 2.

It should be understood that sound generated by the sound generating unit 8 may be detected by the microphone 2. When the sound hole 31 is normal, the sound generated by the sound generating unit 8, after being detected by the microphone 2, can form a normal-strength detection signal. When the sound hole 31 is clogged by water, frost or ice, intensity of the sound detected by the microphone 2 may be reduced. Therefore, a detection signal formed after the microphone 2 detects the sound may decrease. In this way, the sound generating unit 8 and the microphone 2 together form a detection system for water, frost and ice in the sound hole 31. It should be understood that the printed circuit board 5 integrates a judgment circuit for detecting signal strength, so that load on the electronic terminal and occupation of a communication interface can be reduced.

In an embodiment, based on the detection system formed by the sound generating unit 8 and the microphone 2, prior to step S10, the defrosting method further includes the following steps.

In S0, the sound generating unit 8 is controlled to generate sound, and it is detected whether a signal of the microphone 2 reaches a threshold. If the signal of the microphone 2 is greater than or equal to the threshold, the action of controlling the sound generating unit 8 to generate sound, and detecting whether a signal of the microphone 2 reaches a threshold is repeated after a first delay duration T1. If the signal of the microphone 2 is smaller than the threshold, the heating instruction is sent to the heating unit 4.

In an embodiment, after a defrosting function is enabled, at every interval of the first delay duration T1, an action of detecting whether the sound hole 31 is clogged by water, frost or ice is performed once. The first delay duration T1 may be adaptively set according to an actual situation, such as 30 s, 60 s, 10 min, 0.5 h, 1 h, 2 h, or 5 h. The detection action causes the sound generating unit 8 to generate sound. Since the sound generating unit 8 and the sound hole 31 are spaced apart and located on a same side, the sound generated by the sound generating unit 8 may enter the sound hole 31. It should be understood that parameters of the sound generated by the sound generating unit 8 are the same each time, thereby ensuring that sound signals inputted to the sound hole 31 during the detection are consistent.

In this way, intensity of sound received by the microphone 2 may be different in the case of clogging and unclogging of the sound hole 31. Whether the sound hole 31 is clogged may be determined by comparing intensity of a sound detection signal detected by the microphone 2 with a threshold. The threshold is obtained by laboratory calibration testing. When the signal of the microphone 2 is greater than or equal to the threshold, the sound hole 31 is not clogged, in which case no defrosting operation is performed. When the signal of the microphone 2 is smaller than the threshold, the sound hole 31 is clogged, in which case heating and defrosting actions of the heating unit 4 are performed.

In an embodiment, in S20, the detecting current performance of the microphone 2, and disabling the heating action of the heating unit 4 if the current performance of the microphone 2 is normal, includes:
controlling the sound generating unit 8 to generate sound, and detecting whether a signal of the microphone 2 reaches a threshold; disabling, by the heating unit 4, the heating action if the signal of the microphone 2 is greater than or equal to the threshold; and repeating, if the signal of the microphone 2 is smaller than the threshold, the action of controlling the sound generating unit 8 to generate sound, and detecting whether a signal of the microphone 2 reaches a threshold after a second delay duration T2.

It should be understood that parameters of the sound generated by the sound generating unit 8 in this step are the same as those in step S0, the threshold is also the same, and the manner of judging whether there is clogging is also the same. Details are not described herein again. During the heating and defrosting, a clogging detection action is performed every second delay duration T2. In the case of unclogging, the heating action of the heating unit 4 is disabled, which can effectively remove the water, frost and ice in the sound hole 31 and ensure reliability of the performance of the microphone 2. Moreover, the heating is stopped immediately after detection of unclogging, which can effectively save power consumption and prevent degradation of pickup quality of the microphone 2 at higher temperatures. The second delay duration T2 may be adaptively set according to an actual situation, which may be set to 3 s, 5 s, 10 s, 15 s, 20 s, 30 s, or the like.

In order to prevent the sound generating unit 8 from disturbing a user, in some embodiments, during leakage detection, the sound generated by the sound generating unit 8 may be set to be ultrasonic waves or infrasound waves outside a human hearing range.

The above are merely embodiments of the present disclosure. It should be noted herein that, for those of ordinary skill in the art, improvements can be made without departing from the creative concept of the present disclosure, all of which fall within the protection scope of the present disclosure.

What is claimed is:

1. A microphone module, comprising: a housing with a receiving space, and a microphone mounted in the receiving space, wherein the microphone module further comprises a heat-conducting ring embedded in the housing and a heating unit connected to the heat-conducting ring, wherein a sound hole corresponding to a position of the microphone is formed inside the heat-conducting ring, and the heating unit is configured to provide heat to the heat-conducting ring.

2. The microphone module as described in claim 1, wherein the heating unit is in a shape of an annular sheet, the heating unit is attached to a side of the heat-conducting ring close to the receiving space, and an inner hole of the heating unit surrounds an outer side of the sound hole.

3. The microphone module as described in claim 2, further comprising: a printed circuit board assembled in the receiving space, and a waterproof film attached to a side of the printed circuit board close to the heating unit, wherein the microphone is assembled on a side of the printed circuit board away from the heating unit, a sound channel is provided on the printed circuit board corresponding to the position of the microphone, and the waterproof film covers one end of the sound channel.

4. The microphone module as described in claim 3, further comprising: a sealing rubber ring clamped between the heating unit and the waterproof film, wherein a through hole of the sealing rubber ring surrounds outer sides of the sound hole and the sound channel.

5. The microphone module as described in claim 3, wherein one side of the housing protrudes to form a connection end, and the printed circuit board comprises a connection pin extending from the receiving space into the connection end.

6. The microphone module as described in claim 1, further comprising: a sound generating unit mounted on the housing and spaced apart from an outer end of the sound hole.

7. The microphone module as described in claim 6, wherein one side of the housing protrudes to form a mounting platform, and the sound generating unit and the heat-conducting ring are mounted in the mounting platform.

8. A defrosting method, used for the microphone module as described in claim 1 and comprising the following steps:
enabling a heating action of the heating unit in response to a heating instruction; and
detecting current performance of the microphone, and disabling the heating action of the heating unit if the current performance of the microphone is normal.

9. The defrosting method as described in claim 8, prior to the enabling a heating action in response to a heating instruction, comprising:
controlling the sound generating unit to generate sound, and detecting whether a signal of the microphone reaches a threshold;
repeating, if the signal of the microphone is greater than or equal to the threshold, the action of controlling the sound generating unit to generate sound, and detecting whether a signal of the microphone reaches a threshold after a first delay duration; and
sending the heating instruction to the heating unit if the signal of the microphone is smaller than the threshold.

10. The defrosting method as described in claim 8, wherein detecting current performance of the microphone, and the disabling the heating action of the heating unit if the current performance of the microphone is normal, comprises:
controlling the sound generating unit to generate sound, and detecting whether a signal of the microphone reaches a threshold;
disabling, by the heating unit, the heating action if the signal of the microphone is greater than or equal to the threshold; and
repeating, if the signal of the microphone is smaller than the threshold, the action of controlling the sound generating unit to generate sound, and detecting whether a signal of the microphone reaches a threshold after a second delay duration.
